(19) United States
(12) Patent Application Publication
(10) Pub. No.: US 2025/0281828 A1
(43) Pub. Date: Sep. 11, 2025

(54) APPLICATION PERIPHERAL AND METHOD

(71) Applicant: Sony Interactive Entertainment Inc., Tokyo (JP)

(72) Inventor: Douglas Ralph Ealey, London (GB)

(73) Assignee: Sony Interactive Entertainment Inc., Tokyo (JP)

(21) Appl. No.: 19/070,927

(22) Filed: Mar. 5, 2025

(30) Foreign Application Priority Data
Mar. 8, 2024 (GB) 2403374.8

(51) Int. Cl. A63F 13/285; A63F 13/235; A63F 13/24; A63F 13/837

(52) U.S. Cl. CPC A63F 13/285; A63F 13/235; A63F 13/24; A63F 13/837

(57) ABSTRACT

A haptic feedback module, comprises a linear impact unit, comprising in turn a linear motion driver, mechanically coupled to a first mass, and configured to linearly move the first mass thereby generating a reaction force to be felt by a user of the haptic feedback module; and at least one additional mass, retainable at a position separate from motion of the first mass by a retention mechanism; wherein upon receipt of a signal to increase the reaction force, the retention mechanism is configured to release the at least one additional mass to magnetically couple with the first mass.

### CROSS REFERENCE

The present application claims priority to United Kingdom (GB) Application No. 2403374.8, filed Mar. 8, 2024, the contents of which is incorporated by reference herein in its entirety for all purposes.

### BACKGROUND OF THE INVENTION

### Field of the invention

The present invention relates to an application peripheral and method.

### Description of the Prior Art

Videogame systems have previously provided gun shaped controllers for playing shooting games. Originally these relied upon the timing of cathode ray tube rasterization to detect where the gun was aimed on screen. With the advent of LCD and OLED screens, this approach was no longer feasible and so motion tracking and camera-based tracking of the gun was employed. This approach is also suitable for VR games, where a TV screen may not be employed at all, or may be showing a different image to that displayed to the wearer of the HMD.

In addition, gun shaped controllers have sought to provide haptic feedback, typically using an asymmetric mass coupled to a motor to generate a vibration or rumble (a so-called ‘rumble-pack’). The motor can then be activated to create a brief single-shot vibration or an ongoing machine-gun vibration.

However, this feedback is not particularly realistic.

The present invention seeks to address or mitigate this problem for application peripherals, including videogame guns.

### SUMMARY OF THE INVENTION

Various aspects and features of the present invention are defined in the appended claims and within the text of the accompanying description.

In a first aspect, a haptic feedback module is provided in accordance with claim 1.

In another aspect, a haptic feedback method is provided in accordance with claim 14.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of a system comprising an entertainment device, and at least a first peripheral comprising a haptic feedback module, in accordance with embodiments of the present description.

FIG. 2 is a schematic diagram of a peripheral comprising a haptic feedback module, in accordance with embodiments of the present description.

FIGS. 3A and 3B are schematic diagrams of a linear impact unit, in accordance with embodiments of the present description.

FIGS. 4A to 4C are schematic diagrams of a linear impact unit, in accordance with embodiments of the present description.

FIGS. 5A and 5B are schematic diagrams a mass retention and release mechanism, in accordance with embodiments of the present description.

FIGS. 6A to 6D are schematic diagrams of a linear impact unit, in accordance with embodiments of the present description.

FIG. 7 is a flow diagram of a haptic feedback method, in accordance with embodiments of the present description.

### DESCRIPTION OF THE EMBODIMENTS

An application peripheral such as for example a video game gun, and an associated method, are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

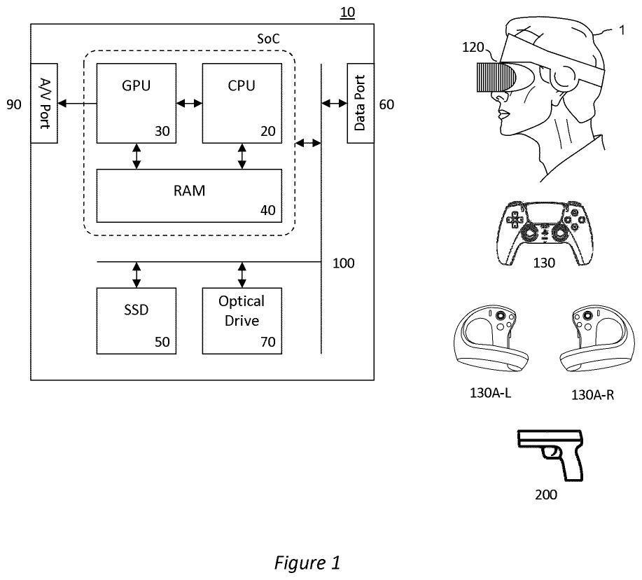

Referring now to the drawings, wherein like reference numerals designate identical or corresponding parts throughout the several views, FIG. 1 shows, as an example of an entertainment system 10, a computer or videogame console.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC).

Further storage may be provided by a disk 50, either as an external or internal hard drive, or as an external solid state drive, or an internal solid state drive.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90 or one or more of the data ports 60.

Where components are not integrated, they may be connected as appropriate either by a dedicated data link or via a bus 100.

An example of a device for displaying images output by the entertainment system is a head mounted display ‘HMD’ 120, worn by a user 1.

Interaction with the system is typically provided using one or more handheld controllers 130, and/or one or more VR controllers (130A-L,R) in the case of the HMD.

In embodiments of the present description, such interaction comprises, or also comprises, using one or more gun-shaped controllers (or ‘gun controllers’, ‘video game guns’, or simply ‘guns’ herein) 200. It is desirable to provide a linear recoil effect, and further to provide one that can vary according to the type of in-game weapon the gun peripheral currently represents.

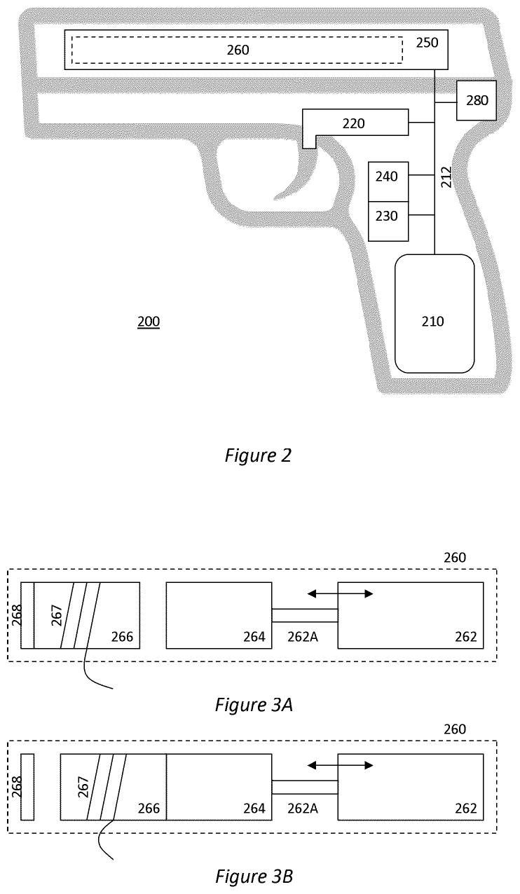

Turning now to FIG. 2, the gun 200 typically comprises a battery 210, which connects to other components of the gun via a suitable power bus 212.

The gun also comprises a trigger mechanism 220, which may be a simple switch, and/or pressure sensitive, and/or comprise a force feedback and/or resistance mechanism, in a similar manner to so-called trigger buttons on conventional videogame controllers.

The gun may also comprise a motion detection unit 230, for example comprising one or more accelerometers and/or gyroscopes, in a similar manner to conventional videogame controllers.

The gun may also comprise a transmitter/receiver 240 for transmitting signals to the entertainment device, for example relating to the activation of the trigger mechanism 220 by the user, and optionally motion data from the motion detection unit, and optionally for receiving signals from the entertainment device, as discussed elsewhere herein.

The gun may also comprise visual elements (not shown) to assist with camera based tracking. For example the gun may have a light at one or both ends of the barrel, and/or a light on top of the gun and/or on one or both sides. Alternatively or in addition the gun may comprise specific colours and/or patterns to assist with visual tracking. The lights, colours, and/or patterns may be arranged to assist a camera located near to a TV (e.g. particularly assist with tracking the front of the gun in normal use and so located there) and/or may be arranged to assist a camera located on an HMD (e.g. particularly assist with tracking the top and/or rear of the gun and so located there).

Optionally the gun may comprise other inputs associated with a conventional controller used with the entertainment device, such as a button that causes the operating system of the entertainment device to interrupt the game, or one or more buttons normally found on a conventional controller, one of which may be mapped, for example, to an ammunition re-load function in-game, or a zoom function in-game, or a crouch or jump function, or the like. In short, the gun may optionally comprise some or all of the functionality and inputs of a conventional controller, but in a gun form factor. By extension it will be appreciated that the gun is a non-limiting example of a controller form-factor and any peripheral that would benefit from the apparatus and techniques herein may be considered.

In embodiments of the present description the gun also comprises a haptic module 250. The haptic module may comprise a rumble pack but, referring now to FIGS. 3A,B and 4A,B, in any event comprises a linear impact unit 260. In the event that the haptic module 250 only comprises the linear impact unit 260, then they may be considered equivalent.

The linear impact unit 260 comprises a linear motion driver such as a linear solenoid (e.g. a push-pull solenoid) 262 typically with a pin 262A that is pushed/pulled by the action of the solenoid. The pin 262A in turn is coupled to a first mass 264. Hence more generally, the linear motion driver 262 is mechanically coupled to the first mass 264.

Using this arrangement, the linear impact unit can provide a sense of linear impact by quickly pulling the mass toward the solenoid, or pushing it away, to create a reaction force felt by the user. This can be used to create a sense of recoil when firing an otherwise virtual projectile. The solenoid can then move the mass in the opposite direction (potentially more slowly to avoid a sense of reverse-recoil, using either a lower voltage/current to drive the solenoid, and/or making use of a spring to resist movement in that direction). The gun can then ‘fire’ and generate a haptic recoil effect again and again by repeating this process. Hence the a linear motion driver/solenoid can linearly move the first mass back and forth, thereby creating a recoil effect through reaction force.

If the gun switches to a machine-gun type mode in-game, then the mass can be rapidly pulled and pushed according to the notional firing rate of the gun. In this case the solenoid may push the mass back out more quickly to achieve the notional firing rate, for example using a higher voltage/current.

In this way, the gun comprising the linear impact unit can provide a haptic recoil effect when the gun is fired.

However in-game, the type of gun may be changed, for example with an in-game pistol being swapped for an in-game shotgun. In this case, providing the same haptic recoil effect may feel unsatisfactory or unexpected.

Accordingly, in embodiments of the present description, the linear impact unit 260 comprises at least a second mass 266. This second mass is not permanently coupled to the first mass, but can be selectively attached using one of several mechanisms. By selectively attaching or detaching the second mass in response to the type of in-game gun in use, a different degree of haptic recoil effect can be chosen.

With reference to FIGS. 3A and 3B, in one mechanism second mass 266 is retained beyond the maximum extent of first mass 264 by a magnet 268 (e.g. a permanent magnet). However, second mass 266 comprises an electromagnet (indicated by coils 267) electrically coupled to a controller 280. When the controller causes the electromagnet to activate, it repels the magnet 268, or at least negates or reduces its attraction for the second mass, so that the second mass is free to be magnetically attracted to the first mass 264 and couple with it.

The linear motion driver can then push/pull the combined mass of magnetically coupled masses 264 and 266, resulting in a larger haptic recoil effect.

If the in-game gun changes again so that a smaller mass is more suitable, or more generally when it is time to reduce the mass being moved, the controller causes the electromagnet to deactivate. Now, when the first mass is pushed again, it pushes the now uncoupled second mass back toward the permanent magnet, which attracts it back to its retained or parked position.

Hence in this way, when the electromagnet is activated, the combined mass for the recoil action is increased, and when the electromagnet is deactivated, the additional second mass can be parked out of the way of operation of the first mass.

The controller 280 controls the electromagnet to control the selective attaching or detaching the second mass for example in response to a signal received by the transmitter/receiver 240 from the entertainment device 10.

Typically the controller also controls the linear motion driver (e.g. linear solenoid); whilst this can be directly coupled to the trigger mechanism, it would not be straightforward to then implement behavioural changes such as firing rates, or preventing firing during a notional reload period, which can be implemented by the controller in response to suitable signals from the entertainment device or a reload button on the gun itself.

It will be appreciated that the electromagnet for the second mass 266 consumes battery power when in use. Hence in embodiments of the present description, optionally a power cycle may be used in which the electromagnet turns off or is significantly weakened when the linear solenoid and combined masses are fully retracted (and hence the second mass does not currently need to be pulled), and/or is turned off or significantly weakened for the majority of the push phase of the solenoid, only coming on to prevent the second mass being pushed toward the permanent magnet near the end of the push cycle. Meanwhile the electromagnet is typically on during the whole of the pull cycle, as it is the magnetism that couples the masses during this phase.

Optionally, to avoid or reduce an initial haptic effect of the second mass moving from its parked position with the permanent magnet to an active position with the first mass (e.g. as the second mass is initially pulled toward and impacts the first mass when the electromagnet is first turned on), this can be done either with the first mass being extended further than in normal use, e.g. to contact the second mass in its marked position, or if pushing/pulling the solenoid at its maximum extension is desirable to improve the haptic recoil effect (end hence the maximum extent should not cause the first mass to touch the parked second mass) then the activation of the electromagnet may be timed to cause the second mass to chase the first mass as it is pulled back, so that there is a combined impact when the first mass reaches the full retracted position of the solenoid and the second mass also hits the first mass. This need only be an optional consideration for the one transition action of the gun when switching to a larger recoil.

Whilst reference has been made to the electromagnet being on the second mass, in principle it could be attached to the first mass instead; however this is less efficient, firstly as it means with electromagnet is moved with every recoil action, and secondly because it can reduce the ability of the electromagnet to nullify the influence of the permanent magnet on the second mass, or require a more powerful electromagnet to overcome the attraction of the permanent magnet.

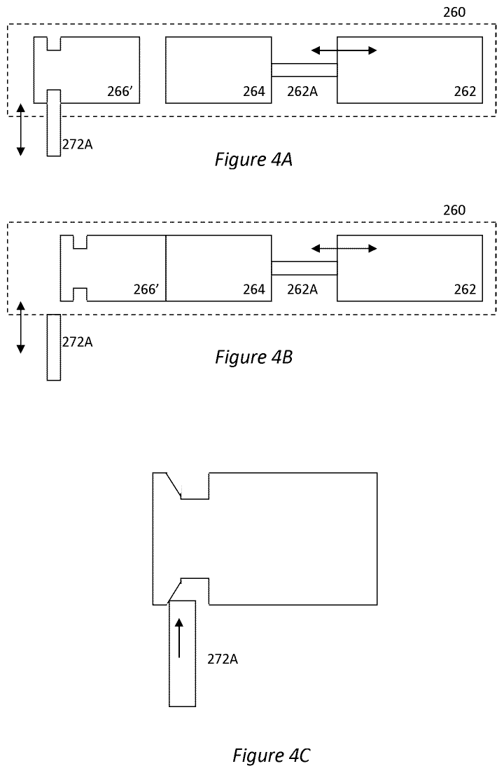

With reference now to FIGS. 4A and 4B, in a second mechanism at least one of the first mass 264 and the second mass 266 is a permanent magnet, arranged so that the two masses would magnetically couple if free to do so.

In this case, the second mass 266 is prevented from coupling with the first mass by a retaining pin 272A, itself coupled to a solenoid (not shown). The retaining pin interacts with a socket (e.g. a hole, or a channel to allow for incidental rotation of the mass, if cylindrical) to prevent lateral movement at least toward the first mass.

Initially, the linear impact unit 260 operates in the same manner as before, using the push/pull of the solenoid 262 to generate a haptic recoil effect using the first mass 264.

However, now referring to FIG. 4B, in the case when an in-game pistol being swapped for an in-game shotgun, or more generally a larger haptic recoil is desired, the retaining pin 272A is retracted (for example as the first mass reaches its closest point to the second mass) leaving the second mass free to magnetically couple with the first mass to form a larger combined mass. The gun then operates again in the same manner as before, but this time without the need for providing or powering an electromagnet on the second mass. This makes this second mechanism more power efficient than the first.

The power efficiency can be further improved if the solenoid driving the retention pin is a latching solenoid; that is, one that is only powered on to change state between extended and retracted positions.

Hence in this case during the generation of haptic recoil, only the linear motion driver/solenoid 262 consumes power, whilst the latching solenoid only consumes power when the gun switches state between first mass only and combined mass.

When the gun is to switch back to using the first mass only, the retaining pin 272A can be extended when the combined mass is at its maximum extension in order to reengage with the second mass 266.

Optionally, and referring now to FIG. 4C, one side of the hole or channel of the second mass 266 can be at least partially chamfered so that the retaining pin 272A can start to engage with it when the combined mass is at or within its maximum extension. This allows for the first mass to then disengage from the second mass when it is pulled back by the linear solenoid 262, but then the pin can also cause the second mass to move slightly further away as it more fully engages, with the upward push of the retaining pin translating into a lateral push of the second mass further from the first mass. This then leaves a small gap between the first and second masses when the first mass alone is at full extension. This small gap can be overcome by magnetic attraction when the retaining pin is withdrawn.

Hence in this way, when the retaining pin is retracted, the combined mass for the recoil action is increased, and when the retaining pin is re-engaged, the additional second mass can again be parked out of the way of operation of the first mass; but with this second mechanism, the power used to combine the masses is less, thereby extending battery life.

This principle can be extended to multiple addition masses by the use of multiple retaining pins with respective solenoids.

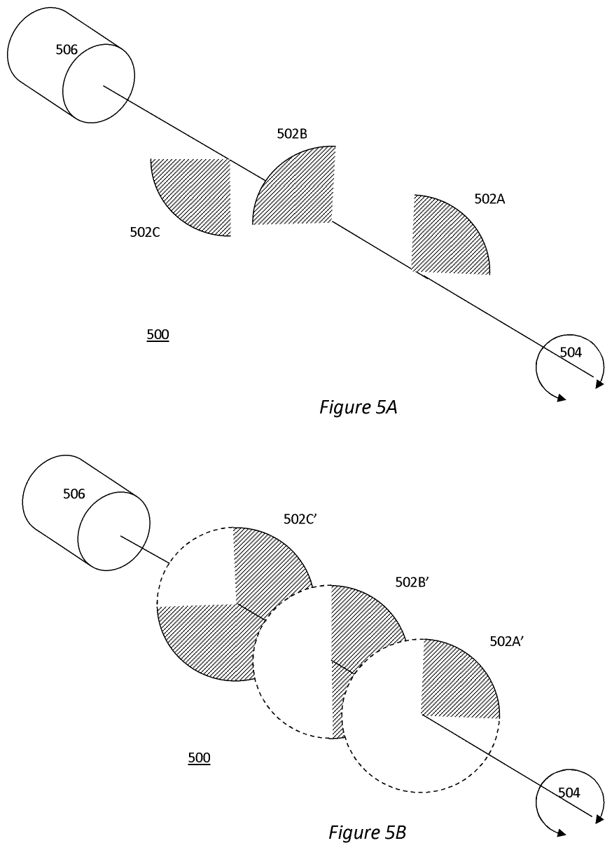

Alternatively, referring now to FIGS. 5A-B and 6A-D, a different mechanism can more simply select multiple additional masses.

FIG. 5A shows a mechanism for selecting a specific number of masses to add to first mass 264.

Fins 502A, 502B, and 502C are rotationally offset so that only one fin can intersect with a corresponding mass at a time, as the axle 504 is rotationally repositioned by motor 506. Hence in this case, each fin acts like retaining pin 272A, but is raised and lowered relative to a corresponding mass by virtue of rotation of the axle. The fins interact with a channel in the corresponding mass in a similar manner to the retaining pin described previously to retain or release it.

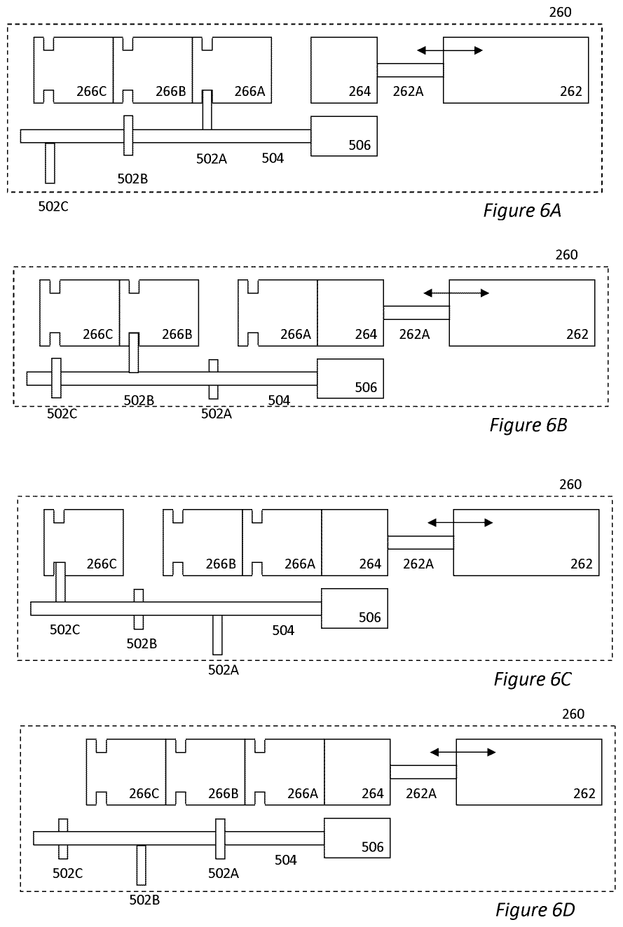

This process is shown in FIGS. 6A-D, where four rotational positions of the fins show their engagement with the masses 266A-C, resulting in four possible configurations of masses for the linear impact unit. It will be seen that selectively 0, 1, 2, or 3 additional weights can be added with the mechanism by selective rotation of the axle 504 to engage the relevant fin with the channel of a respective mass to hold or release the next mass in turn.

It will be appreciated that reversing the axle rotation will step back down the number of masses attached, and similarly progressing to a full revolution (From FIG. 6D to FIG. 6A) will re-lock all the additional masses at once and decouple them from the first mass 264. Like FIG. 4C, the masses and/or fins can be shaped to initially engage within the range of movement of the coupled masses, but fully engage with the mass at a position outside the range of movement of the coupled masses.

It will be appreciated that the number of fins and corresponding masses in the figures is exemplary only and the mechanism can be used for one additional mass or a plurality of additional masses.

In an alternative approach shown in FIG. 5B, the fins can be arranged so that the additional masses are not retained only by the fin corresponding to the next mass to be released, but can be arranged so that a plurality of the additional masses are held by respective fins when not coupled to the first mass 264. This is done by having fins occupying consecutively more of the arc of the full circle, so that they engage with their corresponding mass for more of the rotation of the axle. Otherwise, the mechanism is essentially the same, but may reduce wear in particular on first fin 502A by sharing the retention load between more fins.

In either case, again this mechanism is power efficient as the motor 506 only needs to move when changing the amount of coupled mass.

It will be appreciated that in any of the mechanisms described herein, the retained or parked position of the or each additional mass may be very close to the maximum extension of linear movement of the first mass and any currently coupled additional masses. This can potentially result in air compression or restricted airflow resisting the motion as the masses come close to each other. This makes the system less efficient as the linear motion driver 262 must do more work to overcome the air resistance. It can also reduce the peak reaction force of the linear impact unit by acting as an air cushion. Accordingly, optionally the linear impact unit, further optionally the haptic feedback module, and further optionally still the gun (or other peripheral housing the haptic feedback module) may comprise air vents to allow expulsion and ingress of air.

In the linear impact unit, the retained/parked position(s) of the or each additional mass are known, and so one or more air vents can be positioned to coincide with the minimal gap between the retained and moving masses. This can be repeated just ahead of the retained/parked position of each additional mass as needed, so that air can be easily expelled and drawn in as the first mass and any currently coupled additional masses act like a piston within the linear impact unit.

It will be appreciated that the linear impact unit 260 may be incorporated into the haptic feedback module, or operate as the haptic feedback module 250 if there are no other haptic elements within it. In turn the linear impact unit/haptic feedback module can be incorporated into a peripheral device such as videogame gun 200, but potentially any device that would benefit from a linear impact haptic effect, including VR controllers 130, controller 130, or indeed HMD 120 (e.g. to simulate being hit by a shot).

The peripheral device itself may also receive signals/commands from an entertainment device running an application with which the peripheral interacts; for example a console running a videogame or PC running a simulation. As such a system comprising the peripheral device and entertainment device can incorporate the linear impact unit/haptic feedback module and also implement its method of operation. Typically the signals regarding what recoil force to produce/number of masses to couple will be provided by the entertainment device, but potentially these may alternatively or in addition be provided by the peripheral itself independently, either by use of a selection input on the peripheral, or because the peripheral also has access to the application/game state either because it is running the game or it has access for other reasons (e.g. to provide a second screen, or an ammunition counter, or the like).

Returning to FIG. 2, in a summary embodiment of the present description, a haptic feedback module 250 comprises the following, as described elsewhere herein.

A linear impact unit 260, as described elsewhere herein, comprising in turn:

A linear motion driver 262 mechanically coupled to a first mass 264, and configured to linearly move the first mass thereby generating a reaction force to be felt by a user of the haptic feedback module, as described elsewhere herein;

At least one additional mass (266, 266′, 266A-C), retainable at a position separate from motion of the first mass by a retention mechanism (268, 272A, 500), as described elsewhere herein; and wherein

Upon receipt of a signal to increase the reaction force, the retention mechanism is configured to release the at least one additional mass to magnetically couple with the first mass, as described elsewhere herein.

Instances of this summary embodiment implementing the methods and techniques described herein (for example by use of suitable software instruction) are envisaged within the scope of the application, including but not limited to that:
when the at least one additional mass is magnetically coupled with the first mass, then upon receipt of a signal to decrease the reaction force, the retention mechanism is configured to retain the at least one additional mass at a position separate from motion of the first mass, as described elsewhere herein;
the module comprises a plurality of additional masses, and the retention mechanism is configured to retain or release a selected number of the additional masses, as described elsewhere herein;
the or each additional mass comprises an engagement recess (e.g. a hole or slot), and the retention mechanism comprises respective engagement protuberances (e.g. a pin or fin) operable to selectively engage with a corresponding mass to retain it, as described elsewhere herein;
   in this case, optionally the or each respective engagement protuberance is driven by a respective solenoid, as described elsewhere herein;
   similarly in this case, optionally the or each respective engagement protuberance is mounted on an axle to occupy a respective portion of an arc of a circle; and selective rotation of the axle results in selective engagement of one or more respective engagement protuberances each with a corresponding additional mass, as described elsewhere herein;
the at least one additional mass comprises an electromagnet, and the retention mechanism comprises a permanent magnet positioned to retain the at least one additional mass when the electromagnet is turned off and the retention mechanism repels the additional mass when the electromagnet is turned on (or equivalently the electromagnet negates the effect of the permanent magnet to a sufficient extent that the electromagnet can couple instead to the first mass), as described elsewhere herein;
the module comprises one or more air vents positioned coincident with a gap that forms between a retained additional mass and a moving mass at its closest point to the retained additional mass, as described elsewhere herein;
a peripheral device (for example gun 200, VR controller 130, controller 130, or indeed VR headset 120) comprises the haptic feedback module, as described elsewhere herein;
   in this case, optionally the peripheral device comprises an input for receiving an indication that the haptic feedback module should generate a reaction force, and an input for receiving an indication of the level of reaction force, the level corresponding to one of a plurality of configurations of coupled or uncoupled additional masses with the first mass, as described elsewhere herein;
      In this case in turn, optionally the input for receiving an indication of the level of reaction force comprises a wireless receiver operable to receive a signal comprising the indication from a remote videogame console, as described elsewhere herein;
   optionally the peripheral is a gun (e.g. a videogame gun), as described elsewhere herein;
a system comprises the peripheral, and a videogame console, configured to transmit a signal comprising an indication of a level of reaction force, responsive to a current state of an application executed on the videogame console, as described elsewhere herein;

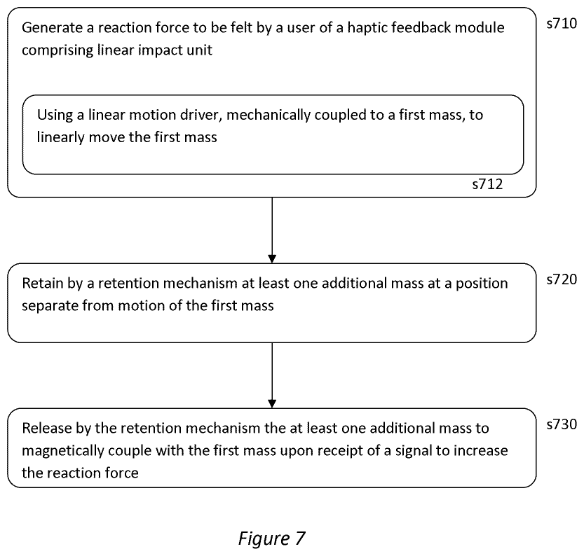

Turning now to FIG. 7, in a summary embodiment of the present description a haptic feedback method comprises the following steps.

In a first step s710, generate a reaction force to be felt by a user of a haptic feedback module comprising linear impact unit, by:

In a first sub-step s712, using a linear motion driver, mechanically coupled to a first mass, to linearly move the first mass; wherein the method further comprises:

In a second step s720, retain by a retention mechanism at least one additional mass at a position separate from motion of the first mass; and

In a third step s730, release by the retention mechanism the at least one additional mass to magnetically couple with the first mass upon receipt of a signal to increase the reaction force.

It will be apparent to a person skilled in the art that variations in the above method corresponding to operation of the various embodiments of the apparatus as described and claimed herein are considered within the scope of the present invention, including but not limited to that when the at least one additional mass is magnetically coupled with the first mass, the method comprises the step of retaining by the retention mechanism the at least one additional mass at a position separate from motion of the first mass upon receipt of a signal to decrease the reaction force.

It will be appreciated that the above methods may be carried out a computer system comprising the haptic feedback module, the system suitably adapted as applicable by software instruction or by the inclusion or substitution of dedicated hardware. The system may comprise the peripheral alone, or also comprise a videogame console, PC, or equivalent device, depending on where the indication of the level of reaction force is selected.

Thus the required adaptation to existing parts of such a system may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A haptic feedback module, comprising:
a linear impact unit, comprising in turn:
a linear motion driver, mechanically coupled to a first mass, and configured to linearly move the first mass thereby generating a reaction force to be felt by a user of the haptic feedback module;
at least one additional mass, retainable at a position separate from motion of the first mass by a retention mechanism; wherein
upon receipt of a signal to increase the reaction force, the retention mechanism is configured to release the at least one additional mass to magnetically couple with the first mass.

2. The haptic feedback module of claim 1, in which:
when the at least one additional mass is magnetically coupled with the first mass,
upon receipt of a signal to decrease the reaction force, the retention mechanism is configured to retain the at least one additional mass at a position separate from motion of the first mass.

3. The haptic feedback module of claim 1, comprising:
a plurality of additional masses; and
the retention mechanism is configured to retain or release a selected number of the additional masses.

4. The haptic feedback module of claim 1, in which:
the or each additional mass comprises an engagement recess; and
the retention mechanism comprises respective engagement protuberances operable to selectively engage with a corresponding mass to retain it.

5. The haptic feedback module of claim 4, in which
the or each respective engagement protuberance is driven by a respective solenoid.

6. The haptic feedback module of claim 4, in which
the or each respective engagement protuberance is mounted on an axle to occupy a respective portion of an arc of a circle; and wherein
selective rotation of the axle results in selective engagement of one or more respective engagement protuberances each with a corresponding additional mass.

7. The haptic feedback module of claim 1, in which
the at least one additional mass comprises an electromagnet;
the retention mechanism comprises a permanent magnet positioned to retain the at least one additional mass when the electromagnet is turned off; and
the retention mechanism repels the additional mass when the electromagnet is turned on.

8. The haptic feedback module of claim 1, comprising one or more air vents positioned coincident with a gap that forms between a retained additional mass and a moving mass at its closest point to the retained additional mass.

9. A peripheral device comprising the haptic feedback module of claim 1.

10. The peripheral device of claim 9, comprising:
an input for receiving an indication that the haptic feedback module should generate a reaction force; and
an input for receiving an indication of a level of reaction force, the level corresponding to one of a plurality of configurations of coupled or uncoupled additional masses with the first mass.

11. The peripheral of claim 10, in which:
the input for receiving an indication of the level of reaction force comprises a wireless receiver operable to receive a signal comprising the indication from a remote videogame console.

12. The peripheral of claim 9 in which the peripheral is a gun.

13. A system, comprising:
the peripheral of claim 9; and
a videogame console, configured to transmit a signal comprising an indication of a level of reaction force, responsive to a current state of an application executed on the videogame console.

14. A haptic feedback method, comprising:
generating a reaction force to be felt by a user of a haptic feedback module comprising a linear impact unit, by:
using a linear motion driver, mechanically coupled to a first mass, to linearly move the first mass; wherein the method further comprises:
retaining by a retention mechanism at least one additional mass at a position separate from motion of the first mass; and
releasing by the retention mechanism the at least one additional mass to magnetically couple with the first mass upon receipt of a signal to increase the reaction force.

15. The haptic feedback method of claim 14, in which:
when the at least one additional mass is magnetically coupled with the first mass, the method comprises the step of
retaining by the retention mechanism the at least one additional mass at a position separate from motion of the first mass upon receipt of a signal to decrease the reaction force.

16. The haptic feedback method of claim 14, in which:
the linear impact unit comprises a plurality of additional masses, and the method comprises:
retaining or releasing a selected number of the additional masses.

17. The haptic feedback method of claim 14, in which:
the or each additional mass comprises an engagement recess, and the method comprises:
selectively engaging with a corresponding mass to retain it.

18. The haptic feedback method of claim 14, in which:
the at least one additional mass comprises an electromagnet;
the retention mechanism comprises a permanent magnet positioned to retain the at least one additional mass when the electromagnet is turned off, and the method comprises:
repelling the additional mass when the electromagnet is turned on.

19. A non-transitory, computer readable storage medium containing a computer program comprising computer executable instructions that when executed by a computer system, cause the computer system to perform a haptic feedback method, comprising the steps of:
generating a reaction force to be felt by a user of a haptic feedback module comprising a linear impact unit, by:
using a linear motion driver, mechanically coupled to a first mass, to linearly move the first mass; wherein the method further comprises:
retaining by a retention mechanism at least one additional mass at a position separate from motion of the first mass; and
releasing by the retention mechanism the at least one additional mass to magnetically couple with the first mass upon receipt of a signal to increase the reaction force.
